(19) United States
(12) Patent Application Publication
(10) Pub. No.: US 2003/0070086 A1
(43) Pub. Date: Apr. 10, 2003

(54) Method of providing security by personalizing a computer application

(75) Inventors: Patrick Blondel, Le Chesnay (FR); Carey Bunks, Paris (FR); Dominique Pavlin, Verneuil/Seine (FR)

Correspondence Address: YOUNG & THOMPSON, 745 SOUTH 23RD STREET 2ND FLOOR, ARLINGTON, VA, 22202

(73) Assignee: NETQUARTZ, NANTERRE CEDEX (FR)

(21) Appl. No.: 10/265,104

(22) Filed: Oct. 7, 2002

(30) Foreign Application Priority Data
Oct. 8, 2001 (FR) 0112910

(51) Int. Cl. H04L 9/00

(52) U.S. Cl. 713/200

(57) ABSTRACT

A method of providing security by personalizing a computer application having executable instructions, the method comprising the steps of installing a modified application on a user computer in which a plurality of groups of instructions needed for complete operation of the application are missing and are replaced by link portions suitable for causing the missing groups of instructions to be executed when said missing groups of instructions are installed in a remote server or in a communication member itself installed on the user computer, in sharing the missing groups of instructions between the communication member and the remote server, and in establishing a link between the communication member and the remote server.

The present invention relates to a method of providing security by personalizing the use of a computer, and it also relates to corresponding program products.

### BACKGROUND OF THE INVENTION

In order to encourage controlled distribution of computer applications, i.e. by distributing applications to people who are authorized while preventing people who are not authorized from running them, it is necessary to provide security measures associated with applications. Such security measures must be effective against fraud, but they must not present too great a constraint for authorized users since otherwise users are liable to lose interest in the application.

In this context, document U.S. Pat. No. 6,009,543 discloses a method of setting up a link between a user and a publisher, that method securing use of the computer application and comprising for this purpose the steps of extracting a portion of the executable code of the computer application, of installing said extracted portion on a remote server, and of replacing the extracted portion in the application by a link portion, such that on running the computer application including the link portion, a link is set up automatically with the extracted portion as installed on the server so as to cause the instructions corresponding to the extracted portion to be executed in the server and so as to cause the results to be sent back to the user computer on which the computer application containing the link portion is installed.

Thus, in the absence of a link with the server it is not possible to run the application, and the functional link established between the user computer and the server is personalized in such a manner as to make it possible each time the link is set up between the user computer and the server to verify that the user is still entitled to access the extracted portion installed on the server.

In order to increase the security provided by that method, proposals are also made in that document to cause the particular portion of the code that is extracted to vary from one user to another so as to personalize the application installed on a remote computer. Nevertheless, that implies that for each user it is necessary to implement a particular transformation of the initial program into two corresponding programs, one installed on the server and the other on the user computer. This involves complicated management of each application at server level.

### OBJECTS AND SUMMARY OF THE INVENTION

An object of the invention is to propose security by personalizing the use of an application while minimizing the burden on the server.

In order to achieve this object, the invention provides a method of providing security by personalizing a computer application that includes executable instructions, the method comprising the steps of installing a modified application on a user computer in which a plurality of groups of instructions needed for complete operation of the application are missing and are replaced by link portions suitable for causing the missing groups of instructions to be executed when said missing groups of instructions are installed in a remote server or in a communication member itself installed on the user computer, in sharing the missing groups of instructions between the communication member and the remote server, and in establishing a link between the communication member and the remote server.

Thus, with a single modified application, it is possible to personalize the application that is made available to any one user by varying the distribution of the missing groups of instructions, while limiting the rate at which data needs to be exchanged with the server because of the limited number of missing groups of instructions that remain installed on the server.

The invention also provides corresponding program products, i.e. a program product for installing on a user computer and a program product for installing on a server.

### BRIEF DESCRIPTION OF THE DRAWING

Other characteristics and advantages of the invention appear on reading the following description of a particular and non-limiting implementation, given with reference to the sole accompanying FIGURE which is a diagram illustrating the method and the program products of the invention.

### MORE DETAILED DESCRIPTION

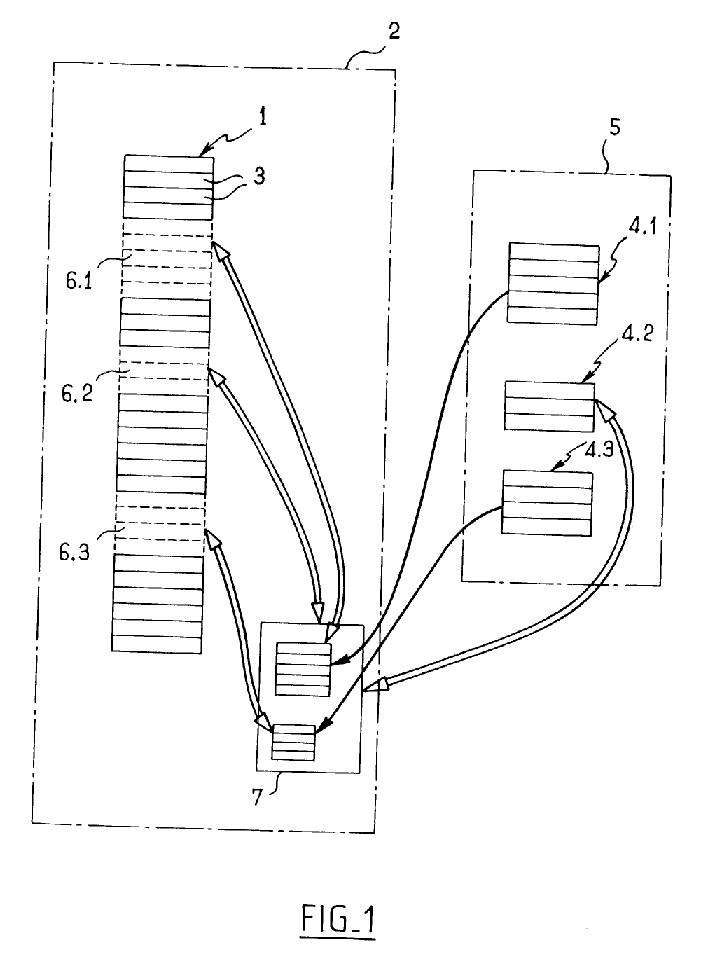

With reference to the FIGURE, a computer application 1 is installed on a user computer 2 and includes a series of executable instructions 3, of which only a very small number are shown in FIG. 1 in order to avoid overloading it. In the implementation shown, three groups of executable instructions, having overall numerical reference 4 and specific numeral references 4.1, 4.2, and 4.3 have been extracted for initial installation on a server 5. The extracted groups of instructions, which groups thus constitute the groups of instructions that are missing from the computer application installed on the user computer 2, are represented by dashed lines in the block representing the application in the user computer 2 where they are replaced in the computer application by link portions given general reference 6 and particular references 6.1, 6.2, and 6.3 corresponding to respective groups of extracted instructions 4.1, 4.2, and 4.3.

The computer application as modified in this way can be supplied in the form of a program product, e.g. being stored on a CD-ROM suitable for being installed by a user on the computer 2.

The link portions 6 have means enabling a local link to be established with a communication member 7 adapted to receive groups of extracted instructions 4 and to execute them locally in association with the corresponding link portions 6. The communication member 7 and the server 5 further comprise means for setting up a link between them in order to execute in the server the missing groups of instructions which are installed in the server.

When the application 1 modified as described above is run for the first time, the link set up with the server 5 serves initially to download a predetermined number of groups of instructions 4 into the communication member 7. In the example shown, the groups of instructions 4.1 and 4.3 are thus downloaded as represented by bold arrows. The particular groups of instructions 4 that are to be downloaded are selected in the server. Preferably, the way in which the groups for installing in the communication member are selected ensures that the probability of two users having the same local distribution of individual blocks is minimized. For example, the first selection can be made at random amongst all possible distributions, and the distribution as downloaded is then stored on each selection and is eliminated from the distributions available for selection until all distributions have been downloaded to different users. All possible distributions are then re-initialized and the same procedure is repeated.

While the application is running, link portions 6.1 and 6.3 are connected to the groups of instructions 4.1 and 4.3 so as to cause them to be executed locally as represented by double-line arrows. The link established with the server 5 thus serves only to execute the group of instructions 4.2 as likewise represented by double-line arrows. It should be observed that this implementation makes it possible to reduce the groups of instructions 4.1 and 4.3 to the form of simple executable files without it being necessary to reconfigure the application, only the communication member 7 needs to be parameterized in order to be able to determine during subsequent operation which data coming from the link portions 6 are to be processed locally and which are to be transmitted to the server 5. So far as the application is concerned all of the missing groups of instructions appear as remote groups of instructions, without distinguishing between those that are local (groups of instructions 4.1 and 4.3) and those which are at a distance (group of instructions 4.2). Naturally, access to the server takes place with verification of user rights. The corresponding program product comprises the modified application together with means for installing the communication member. In order to enable the method to be implemented, the server 5 is loaded with a program product having means for causing groups of executable instructions to be stored, means for selecting groups of instructions and for transferring the selected groups of instructions to a remote computer, and means for executing in the server the remaining groups of instructions on request from the remote computer.

It should be observed that the invention is shown with only three groups of extracted instructions in order to avoid overloading the drawing. In practice, the method of the invention is preferably implemented using a much larger number of groups of extracted instructions, with several groups of extracted instructions being kept at a distance on the server. As an indication, if twenty groups of instructions are extracted, ten of them being kept on the server, then it is possible to perform personalization using more than 180,000 different combinations.

Naturally, the invention is not limited to the implementation described and various embodiments will appear to the person skilled in the art without going beyond the ambit of the invention as defined by the claims.

In particular, although the selection of extracted groups of instructions and their replacement by corresponding link portions is described as taking place on the first occasion the computer application is run, it is also possible to provide for the configuration of the computer application to be modified on an occasion when it is run subsequent to initial installation so as to modify which groups of instructions are kept on the server. Any observations made previously by a user in bad faith for the purpose of reconstructing the remote groups of instructions then become completely unusable.

Although the communication member 7 is shown in the form of a single block having the groups of instructions that are finally reinstalled in the user computer, the communication member 7 could be made up of a plurality of portions, for example a communication module proper and a database organized in substantially the same manner as the server so that, from the point of view of the communication module, access to the various extracted groups of instructions is substantially the same, the only difference being that execution is either local or remote.

1/ A method of providing security by personalizing a computer application having executable instructions, the method comprising the steps of installing a modified application on a user computer in which a plurality of groups of instructions needed for complete operation of the application are missing and are replaced by link portions suitable for causing the missing groups of instructions to be executed when said missing groups of instructions are installed in a remote server or in a communication member itself installed on the user computer, of sharing the missing groups of instructions between the communication member and the remote server, and of establishing a link between the communication member and the remote server.

2/ A method of providing security according to claim 1, wherein the missing groups of instructions are initially installed in the remote server, and wherein at least one missing group of instructions is selected when the modified application is run and is loaded into the communication member.

3/ A method of providing security according to claim 2, wherein the groups of instructions installed in the communication member are selected so that the probability of two users having the same local distribution of individual blocks is minimized.

4/ A method of providing security according to claim 1, wherein the distribution of missing groups of instructions between the communication member and the server is modified on successive occasions that the application is run.

5/ A program product stored on computer-readable storage means, said program product comprising a computer application having executable instructions, in which a plurality of groups of instructions needed for complete operation of the computer application are missing and are replaced by link portions suitable for causing the missing groups of instructions to be executed, the product further comprising means for installing a communication member associated with the application, said communication member being adapted to receive and execute at least one group of missing instructions, and also to establish a link with a server.

6/ A program product according stored on computer-readable storage means, the product comprising means for causing groups of executable instructions to be stored, means for selecting at least one group of instructions as a local distribution and for transferring the selected groups of instructions to a remote computer, and means for executing the remaining groups of instructions on demand of the remote computer.

7/ A program product according to claim 6, wherein the groups of instructions constituting the local distribution are selected so that the probability of two users having the same local distribution of individual blocks is minimized.
